(19) United States
(12) Patent Application Publication
(10) Pub. No.: US 2026/0291813 A1
(43) Pub. Date: Sep. 24, 2026

(54) METHOD AND APPARATUS FOR IMPROVEMENTS IN AND RELATING TO EFFICIENT SERVICE FUNCTION CHAIN PLACEMENT IN A SERVICEBASED TELECOMMUNICATION NETWORK CORE ARCHITECTURE

(71) Applicant: SAMSUNG ELECTRONICS CO., LTD., Suwon-si, Gyeonggi-do (KR)

(72) Inventors: Deval BHAMARE, Staines, Middlesex (GB); Andrea TASSI, Staines, Middlesex (GB); Rasoul BEHRAVESH, Staines, Middlesex (GB); Yue WANG, Staines, Middlesex (GB)

(21) Appl. No.: 19/475,371

(22) PCT Filed: Apr. 15, 2024
(86) PCT No.: PCT/KR2024/005000

§ 371 Date: Oct. 14, 2025

(30) Foreign Application Priority Data
Apr. 14, 2023 (GB) 2305487.7
Mar. 14, 2024 (GB) 2403695.6

(51) Int. Cl. H04L 41/0895; H04L 41/0803

(52) U.S. Cl. CPC H04L 41/0895; H04L 41/0803

(57) ABSTRACT

Embodiments of the present application provide a method of placing Service Function Chains, SFCs, in a service-based architecture of telecommunication network, comprising steps of providing a Network Function, NF, operable to: a)register itself with a Network Resource Function, NRF, so as to make itself discoverable to other NFs; b)gather information and status relating to resources in the telecommunication network, as well as information relating to virtual links; c)gather information and status relating to an underlying physical network, including information relating to physical links, their total and used capacities; d)gather information related to certain Core Network, CN, procedures to be implemented; e)gather information relating to Virtual Network Functions, VNFs, needed to implement the CN procedures and their associated resource requirement; f)implement the placement of the SFCs for the CN procedures to satisfy given user demands, over available infrastructure resources; and g) communicate the placement to at least one further entity.

### TECHNICAL FIELD

The present invention relates to improvements in a service-based architecture (SBA), particularly in the context of the Core Network (CN) of a telecommunication network, such as a Fifth Generation (5G) or Sixth Generation (6G) network. In particular, it relates to an apparatus and method for efficient Service Function Chain (SFC) placement in service-based 5G/6G Core (5GC/6GC) architecture.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

Emergence of 5G as a new global wireless standard is providing significant improvements in the provision of Internet services, such as, mobile broadband. It is also empowering the development, deployment and delivery of new services, for example, smart factories, logistics, remote surgery, precision agriculture and many other applications with low latency requirements. With the advent of cloud-native architecture, 5G core (5GC) has adopted service-based architecture (SBA), where 5GC functionalities are being deployed as Virtual Network Functions (VNFs). For example, Network Functions (NF) such as Access and Mobility Management Function (AMF) or Session Management Function (SMF) are being deployed as VNFs. Such VNFs may be deployed as virtual machines (VM) or may be as micro-services (for example, using containerized approach). This depends on the underlying infrastructure, available resources and the degree of the granularity desired.

### DISCLOSURE OF INVENTION

### Technical Problem

In line with development of the communication systems, there is a need for efficient service function chain placement in a service-based telecommunication network core architecture.

The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

Disclosed is a method of placing Service Function Chains, SFCs, in a service-based architecture of telecommunication network, comprising the steps of providing a Network Function, NF, operable to: a) register itself with a Network Resource Function, NRF, so as to make itself discoverable to other NFs; b) gather information and status relating to resources in the telecommunication network, as well as information relating to virtual links if any virtual resource is present in the telecommunication network; c) gather information and status relating to an underlying physical network, including information relating to physical links, their total and used capacities; d) gather information related to certain Core Network, CN, procedures to be implemented; e) gather information relating to Virtual Network Functions, VNFs, needed to implement the CN procedures and their associated resource requirement; f) implement the placement of the SFCs for the CN procedures to satisfy given user demands, over available infrastructure resources; and g) communicate the placement to at least one further entity.

Such a trend has enabled research into 6G deployments and is likely to continue for 6G core (6GC) as well. In SBA, VNFs are deployed over edge or core cloud resources and related VNFs communicate with each other to form communication chains. For example, VNFs may communicate with each other to complete the request, such as, user registration, to form a chain. Such chains are called Service Function Chains (SFCs). SFCs are nothing but logical topology graphs demonstrating logical connectivity among the NFs. These NFs are then deployed on the physical machines (PM) or servers and the problem is known as SFC embedding. FIG. 1 shows a sample SFC for user registration procedure. Please note that the actual logical flow among the VNFs may vary and FIG. 1 is just for illustration purpose. FIG. 1 shows an AMF, SMF, Unified Data Management (UDM) and Policy Control Function (PCF).

Consider the procedure in FIG. 1 and resource demands by the VNFs to serve unit requests per unit time (for example, 1000 user registration requests per seconds) for this procedure as shown in table 1, below. Note the unit number of user requests does not matter here and can be considered at any given degree of granularity. Also, note there can be any number of resources to be considered, however, only CPU and memory are considered for simplicity.

Let us assume that the SFC is serving 3000 users per second. Recently, to accommodate the increased user demands, NSPs prefer to deploy more than one instance of a single VNF. This approach is called as load-balancing (or horizontal scaling). However, multiple instances of a single VNF can be combined together to form a single instance, with equivalent resources allocated to the single NF. For example, as shown in FIG. 2, three instances of AMF are needed to serve 3000 users, which are combined to form a single instance, with CPU demands of 3 (1×3=3) units and memory demands of 6 (2×3=6) units. Merging such instances allows the administrator to reduce system overheads, such as inter-system calls and state (meta-data) storage space, allowing the performance of the instance to improve.

TABLE 1

| NF name | CPU demands | Memory Demands |
|---|---|---|
| AMF | 1 | 2 GB |
| SMF | 3 | 1 GB |
| UDM | 2 | 1 GB |
| PCF | 1 | 3 GB |

It is to be noted that, not all instances can be merged into a single instance. There could be multiple reasons, for example, not enough resources on a single PM. Another reason could be that it may not be feasible to allocated resources beyond some threshold to a single instance (or vertical scaling). This avoids the NF instance becoming bulky and difficult for migration or replication, if desired. This is a desired property in cloud computing backed service based architecture and can be viewed as a trade-off between vertical scaling and horizontal scaling.

For example, in FIG. 2, it is assumed that not more than 3 units of CPUs can be allocated to a single instance, and hence, 3 different instance of SMF are needed. Note, this threshold may vary as per the system. Such flexible deployment of NFs results in different numbers of instances per NF and complex graph structure of NFs for a given procedure to serve the given number of user requests at a given time instance, as shown in FIG. 2.

The next step in service provisioning is deploying the complex graph of SFCs on physical (substrate) networks and the process is known as embedding of Service Function chains (SFCs). SFC embedding is not a trivial problem and various solutions in the art have been proposed. As can be seen, a simple SFC can get converted into complex graph structures, after load-balancing, making the embedding of the SFC on the physical node even more difficult. A few works in the art focus on embedding of such complex graphs, however, none focus on the similar problem from 5G/6G core (5GC/6GC) perspective. Also, the models proposed in the state-of-the-art are relatively complex to implement, as they seek to deploy the complete load-balanced SFC graph (e.g. FIG. 2) over the substrate network.

Embedding of service function chains, consisting of network functions, over physical substrate network is not a trivial problem, especially in the context of service based architecture in 5GC and 6GC. This problem is more relevant in the context of 6GC as the state-of-the-art including standardisation organisations aim to meet stringent service level agreements (SLAs) with minimal resource footprint to minimize cost and energy consumption. Such service-based or micro-service-based architectures demand efficient placement of the VNFs over the physical resources if one is to experience maximum rewards of such novel architectures. Though the problem of SFC embedding is widely studied, there is no specific solution from the perspective of embedding SFCs for the procedures in 5GC/6GC.

Prior art solutions focus on: (a) Placement of independent load-balanced NFs, without considering the SFCs, or (b) Placement of VNFs considering interactions among them, but neglecting the scenario of multiple instances of a single NF in the chain for load-balancing.

Also, standards do not specify a specific control entity responsible for collecting all the data pertaining to the underlying physical resources as well as 5GC/6GC procedures to be implemented, including the network functions involved and their resource requirements and load-handling capabilities. This information may be essential to the optimal SFC placement problem over the available physical resources.

It is an aim of an embodiment of the present invention to address shortcomings, whether mentioned herein or not.

According to the present invention there is provided an apparatus and method as set forth in the appended claims. Other features of the invention will be apparent from the dependent claims, and the description which follows.

According to a first aspect of the present invention, there is provided a method of placing Service Function Chains, SFCs, in a service-based architecture of telecommunication network, comprising the steps of providing a Network Function, NF, operable to:
a) register itself with a Network Resource Function, NRF, so as to make itself discoverable to other NFs;
b) gather information and status relating to resources in the telecommunication network, as well as information relating to virtual links if any virtual resource is present in the telecommunication network;
c) gather information and status relating to an underlying physical network, including information relating to physical links, their total and used capacities;
d) gather information related to certain Core Network, CN, procedures to be implemented;
e) gather information relating to Virtual Network Functions, VNFs, needed to implement the CN procedures and their associated resource requirement;
f) implement the placement of the SFCs for the CN procedures to satisfy given user demands, over available infrastructure resources; and
g) communicate the placement to at least one further entity.

In an embodiment, in step a) the NF further discovers a Unified Data Repository, UDR.

In an embodiment, in step b), the NF gathers the information from a Virtualized Infrastructure Manager, VIM.

In an embodiment, in step c) the NF gathers the information from a WAN Infrastructure Manager, WIM.

In an embodiment, in step d) the CN procedures are 5GC or 6GC procedures and the information is gathered from a Service Communication Proxy, SCP, or NFV Orchestrator, NFVO, respectively.

In an embodiment, in step e) the information relating to VNFs is gathered from a Service Communication Proxy, SCP, or VNF Manager, VNFM, respectively.

In an embodiment, in step g) the further entity is one of UDR and NFVO.

According to a second aspect of the present invention, there is provided an apparatus arranged to perform the method of the first aspect.

According to an aspect of the present invention, there is provided:
a novel control entity responsible for gathering all the data pertaining to the underlying physical resources as well as 5GC/6GC procedures to be implemented, including the network functions involved and their resource requirements and load-handling capabilities.
interfaces needed for such communication and information exchange.
system model parameters for the relevant entities to be able to communicate and store the desired data.
a novel methodology to be implemented at the novel control entity for optimal placement of complete load-balanced service function chains pertaining to the 5G/6G core over the substrate network so that inter-network IO operations and total resource utilization is minimized.

Although a few preferred embodiments of the present invention have been shown and described, it will be appreciated by those skilled in the art that various changes and modifications might be made without departing from the scope of the invention, as defined in the appended claims.

### Advantageous Effects of Invention

The present disclosure provides an effective and efficient method for service function chain placement in a service-based telecommunication network core architecture.

Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

For a better understanding of the invention, and to show how embodiments of the same may be carried into effect, reference will now be made, by way of example only, to the accompanying diagrammatic drawings in which:

FIG. 1 shows a sample SFC in SB 5G-Core Architecture known in the art;

FIG. 2 shows a modified version of the graph of SFC shown in FIG. 1;

FIG. 3 shows an NFO interacting with NRF according to an embodiment of the invention;

FIG. 4 shows an updated 5GC/6GC architecture according to an embodiment of the invention;

FIG. 5 shows a graph of SFC according to an embodiment of the invention;

FIG. 6 shows a first algorithm relating to according to an embodiment of the invention;

FIG. 7 shows a second algorithm relating to according to an embodiment of the invention;

FIG. 8 shows a flowchart related to the first and second algorithms;

FIG. 9 shows a call graph for Scenario I according to an embodiment of the invention; and

FIG. 10 shows a call graph for Scenario II according to an embodiment of the invention.

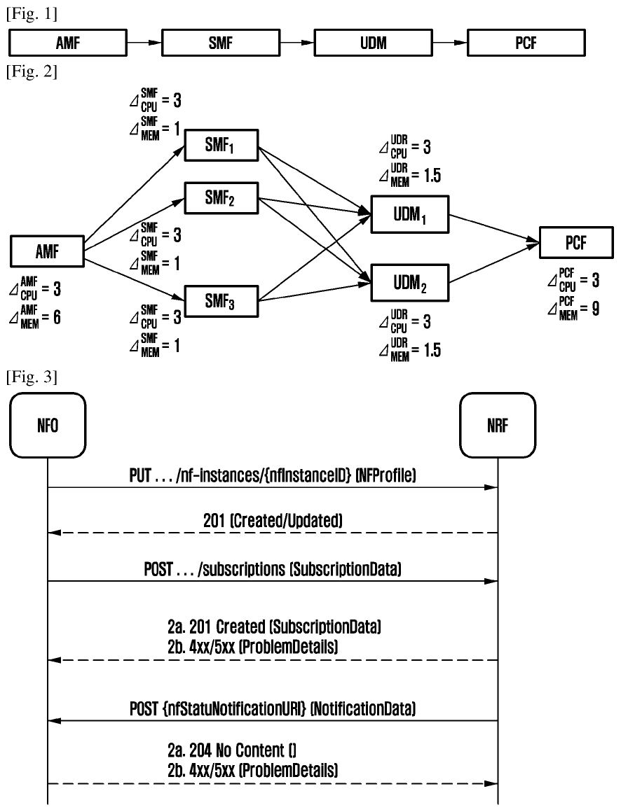

### MODE FOR THE INVENTION

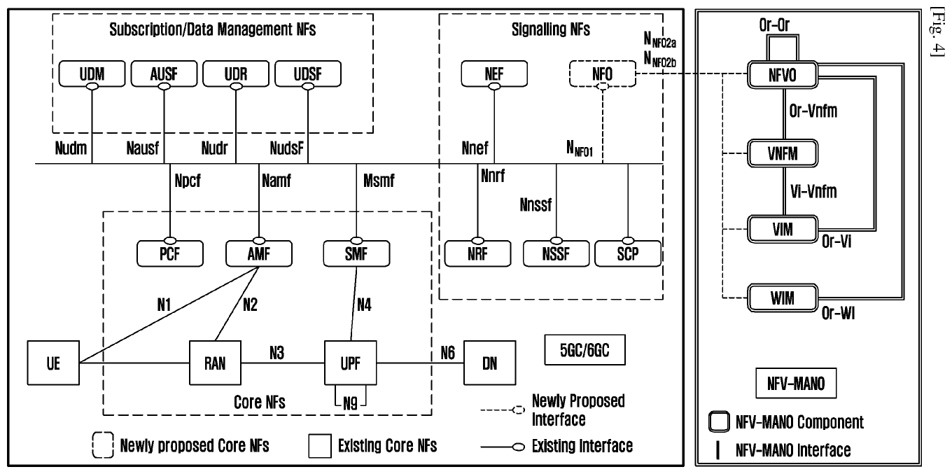

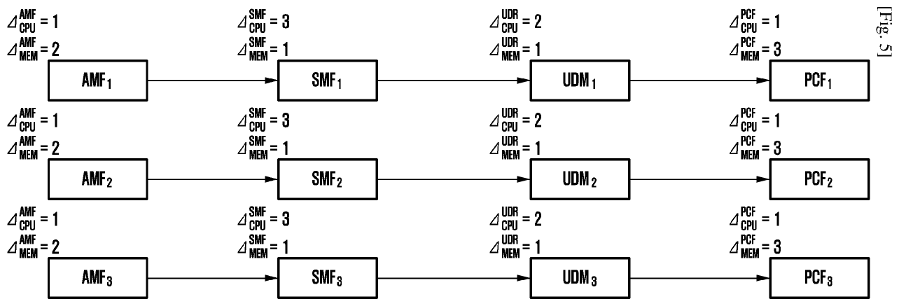

A first embodiment provides a novel control entity responsible for efficient and optimized service function chain placement for load-balanced service based architecture (SBA) in 5G/6G core (5GC and 6GC). Note that the SFCs are composed of VNFs which could be deployed as virtual machines or micro-services using containers. The aforementioned entity is herein referred to as a Network Function Orchestrator (NFO). The NFO performs the following operations:
a. Registers itself with Network Resource Function (NRF) using the interface NFRegister and also discovers the Unified Data Repository (UDR) service using an API call NFStatusSubscribe with NRF (illustrated in FIG. 3). With this, the NFO makes itself discoverable to other NFs and also learns about UDR instances (which are needed to store final placement scheme).
b. Periodically gathers the information and status of resources, that is, total resource capacity of the underlying infrastructure and total used resources on the same. The same interface is also used to get the information about the virtual links if any virtual resource is included. Note that the underlying infrastructure could be mix of physical servers, virtual machines and containers. This is achieved by implementing an API call ‘getResourceInfo’. NFO gets this information from Virtualized Infrastructure Manager (VIM).
c. Periodically gather the information and status of the underlying physical network, that is, total physical links, their total and used capacities. This is achieved by implementing an API call ‘getLinkInfo’. NFO gets this information from WAN Infrastructure Manager (WIM).
d. Periodically gather the information of all the 5GC/6GC procedure to be implemented. This is achieved by implementing an API call ‘getProcedureInfo’. NFO gets this information either from NFV Orchestrator (NFVO) or from Service Communication Proxy (SCP) in 5GC.
e. Periodically gather the information of all the 5GC/6GC VNFs needed to implement the given set of procedures and their resource requirement. This is achieved by implementing an API call ‘getVNFInfo’. NFO gets this information either from VNF Manager (VNFM) or from Service Communication Proxy (SCP) in 5GC.
f. Implements the efficient placement of the service function chains for the set of procedures to satisfy the given user demands, over the available infrastructure resources.

Communicates the placement scheme and stores the output of the algorithm in the UDR and NFVO. This is achieved by implementing an API call ‘putPlacementInfo’. Any system responsible for actual deployment of the VNFs on the underlying infrastructure may retrieve the generated placement scheme from UDR or NFVO, which is outside the scope of this application.

An embodiment provides a novel interface Nnfo to enable communication with NFO in 5GC/6GC and with Network Functions Virtualization Management And Orchestration (NFV-MANO). All proposed API calls are realized over the novel interface Nnfo. Updated 5GC/6GC architecture with the novel entity NFO and the interface Nnfo, along with interactions with NFV-MANO are shown in FIG. 4.

Requests originating from RAN define the nature of the chain of the VNFs or Service Function Chains (SFCs), in a sense that: (1) which set of VNFs will be traversed in which order and (2) what will be the resource demands for each VNF.

Note that the interface N_{NFO} comprises 2, or even 3, separate interfaces. N_{NFO1} is an interface between NFO and the CN main bus and is used to gather the information as set out in steps c) and d) described earlier.

Interface N_{NFO2} may comprise 2 separate interfaces N_{NFO2a} and N_{NFO2b}. Interface N_{NFO2a} is provided to gather the information as set out in step b) described earlier. Interface N N_{NFO2b} is provided to implement step g) described earlier, namely to provide details of the placement.

The following provides further details relating to steps a) to g), described earlier.

In the following A) relates to steps b) and c).
A) To receive data over the interface getResourceInfo and getLinkInfo, the underlying infrastructure resources are defined as tuple (S, E, R), where S={1, . . . , |S|} consists of the list of the servers, E is a |S|×|S| matrix where maximum possible flow between server (server could be virtual server or physical server and herein, the terms server or resource are used as a common term for both) i and j is given by (i,j)^{th} element e_{i,j}∈\tilde{R}, (set of real numbers), and 0, otherwise; if i is equal to j, e_{i,j} is assumed to be equal to 1, thus, signifying the capability that each server has to communicate with itself.

Resource capacity is defined by

$$R = \{ ( {r}_{i}^{cpu} , {r}_{i}^{mem} , {r}_{i}^{…} ) , ∀ i ∈ S \} ,$$

for its available CPU and memory capacities, respectively. Note that rᵢ . . . represents a further set of measurable capacities of the resources, such as I/O bandwidth, storage capacity etc. For brevity, only CPU and Memory are mentioned hereafter. Also, it is assumed that CPU footprints are expressed as the sum of the footprint of each CPU core expressed between 0 and 1, which is then normalized by the maximum CPU footprint supported by all the servers. Similarly, memory footprints are also normalized by the maximum amount of memory that can be allocated by any server. The flow of a network link interconnecting servers is measured in terms of the number of PDUs per second that flow in one direction.

In the following, B) relates to step d).
B) To receive data over the interface getProcedureInfo, Procedure t is defined as a tuple P(t)={N^{(t)}, T^{(t)}, F^{(t)}, L^{(t)}}, where, N^{(t)}={1, . . . , |N^{(t)}|} is a list of the NFs pertaining to a procedure t. T^{(t)} is a VNF traffic matrix, where its (i, j)^{th} element T_{(i,j)}^{t}∈R, (set of real numbers), indicates the traffic micro-service i sends to micro-service j in procedure t for unit user requests, and 0, otherwise.

In the following, C) relates to step e).
C) To receive data over the interface getVNFInfo the resource footprint associated with each VNF while it processes an input request is defined by set

$${F}^{( t )} = \{ ( {f}_{i}^{( t , cpu )} , {f}_{i}^{( t , mem )} ) \vert ∀ i ∈ {M}^{( t )} \} ,$$

where the tuple defines the CPU and memory footprint of NF i, respectively. The resource footprint of NF not processing any input is negligible and it is not considered. NF footprints are normalized by the same factor considered above for the server resources.

In the following, D) relates to steps f) and g).
D) To implement putPlacementInfo define the binary optimization variable

$${x}_{( r , s )}^{( t , i )} ( for i ∈ {N}^{( t )} , s ∈ S , t ∈ \{ 1 , … , \vert P \vert \} , r ∈ \{ 1 , … , {τ}_{i}^{( t )} \} )$$

is defined to be equal to 1 if instance r of NF i, pertaining to procedure t, is mapped onto server s, 0 otherwise.

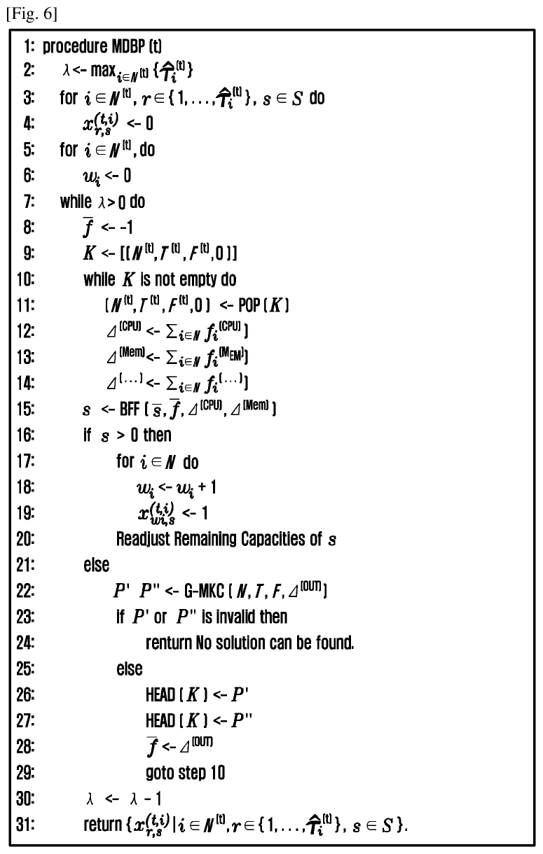

An embodiment of the invention provides a novel scheme of flattening the complex SFC graphs obtained after load-balancing is achieved (that is multiple instances of one or more VNFs and traffic is split among them, as shown, for example, in FIG. 2). In particular, the following description relates to the first part of step f), namely “efficient placement of the service function chains for the set of procedures to satisfy the given user demands”. This approach allows a more efficient multi-bin packing heuristic (algorithm 1, shown in FIG. 6) for efficient SFC embedding (placement) over the underlying infrastructure. This is achieved by dividing the complex graph (shown in FIG. 2) into total instances equal to maximum number of instances needed for a particular VNF in the given procedure. The required resources for each VNF are then adjusted accordingly (shown in FIG. 5). This is achieved by defining two system variables

$${τ}_{i}^{( t )}$$

and λ, as explained below and as shown in algorithm 1 in FIG. 6.

To implement flattening of the SFCs before the efficient algorithm is applied, set

$${L}^{( t )} = \{ {l}_{i}^{t} \vert ∀ i ∈ {M}^{( t )} \}$$

is defined which enumerates the maximum number of concurrent requests (originating from gNBs or other NFs) that each VNF supports before experiencing performance degradation. Finally, set P={P⁽¹⁾, P⁽²⁾, . . . , P^{(|P|)}} (comprises of the procedures supported by the system. Let U^{(t)} be the number of concurrent user requests for procedure t. The number

$${τ}_{i}^{( t )}$$

of instances associated with VNF i pertaining to procedure t is set as

$${τ}_{i}^{( t )} = ⌈ {U}^{( t )} / {l}_{i}^{t} ⌉ .$$

As per the system model, the complex SFC graph in FIG. 2 can be simplified as shown in FIG. 5. The input model is then fed to a Multi-Dimensional Bin Packing (MDBP) heuristic described in algorithm 1 (FIG. 6). With MDBP heuristic, total inter-physical machine (Inter-PM) Network I/O operations or data transfer as well as the total resources needed to embed the given SFC graphs are optimised.

Further, the following description relates to the second part of point f), namely where each SFC is mapped onto the bare metal servers making sure that the following criteria are met:
1. the number of NF instances are not replicated beyond their maximum number;
2. Individually the servers' capacities (CPU, memory, etc) as well as the network link capacities are not violated. It is also necessary to ensure that if two or more instances of a NF need to communicate they shall be mapped into inter-communicating servers or onto the same server;
3. The overall goal of mapping a 3GPP procedure is to minimise a user's definable cost function that may be specified by the user (e.g. a network operator), which may include (but is not limited to)
i) minimizing the network footprint
ii) minimizing the overall number of servers involved in running a procedure.

To Implements an efficient placement of the service function chains for the set of procedures to satisfy the given user demands, over the available physical resources an embodiment provides a heuristic to solve the given problem as a Multi-Dimensional Bin Packing (MDBP) problem (Algorithm 1 FIG. 6). Heuristic steps are explained below.

A variable λ is first initialized to maximum number of instances needed for a NF in the given procedure, i.e.

$$λ = max ( {τ}_{i}^{( t )} )$$

(line 2, algorithm 1).

$$x \begin{matrix}( t , i ) \\ ( r , s )\end{matrix}$$

and wᵢ (intermediate variable) are also initialized to zero (line3-6, algorithm 1). The outer while-loop is executed until all needed instances are not allocated (line 7, algorithm 1). Within outer while-loop, f̅ (line 8, algorithm 1) is initialized. f̅ is summation of outgoing flow out of the partition, from the end NF to the first NF in the next partition, i.e. internal traffic flow among two partitions of the NFs for the single procedure t. Initially, since there is no split in the set of the NFs, hence f̅ is initialized to −1. While placing the partition on a PM s, check that the PM s has at least one physical link with the needed capacity to accommodate f̅ (line 15, algorithm 1). While doing the partition in Greedy Min K-Cut (G-MKC), as explained later, Δ^{out} is updated to be assigned to f̅ (line 27, algorithm 1), which is the traffic flowing between two partitions created by G-MKC.

In this approach, an attempt is made to allocate a single and complete end-to-end linear (flattened) SFC on one single selected physical machine (PM). To achieve this, K is initialized to the set of NFs needed for the given procedure (line 9, algorithm 1). This allows total inter-physical machine (Inter-PM) Network I/O operations to be minimized. An attempt is then made to try to find a PM ‘s’ which can accommodate the complete chain, with needed total CPU capacity and memory (line 15, algorithm 1). IF there are multiple partitions it is necessary to consider the traffic between the partitions, as explained earlier. A Best Fit-First strategy is used to select the candidate PM, such that, the selected PM has minimum but enough capacity to accommodate the SFC with given CPU and Memory requirements as well as least one physical links with the needed capacity to accommodate f̅. If PM s is found, the o/p variable x is adjusted and remaining capacities of the s (line 20, algorithm 1), and readjust the output assignment variable accordingly (line 17-18, algorithm 1).

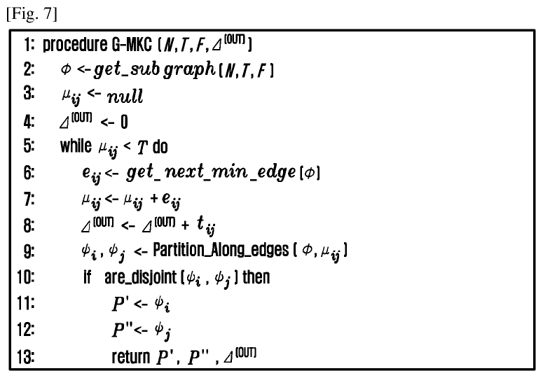

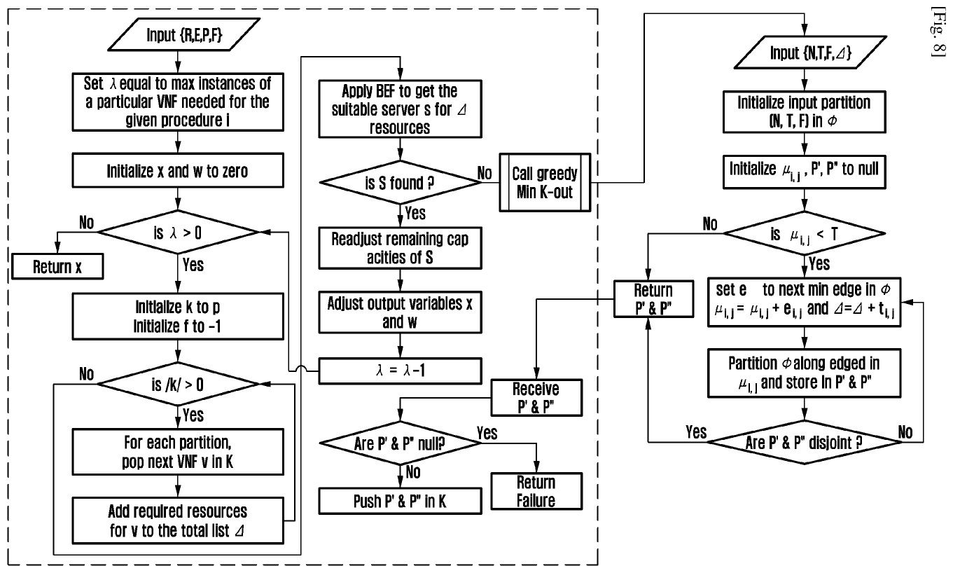

If no such server is found to accommodate the complete SFC, a Min K-Cut heuristic is used to partition the given SFC (line 22, algorithm 1). It ascertains that the SFC graph is split in such a way that inter VNF traffic across two partitions is minimum to minimize overall network I/O, which is one of the goals of embodiments of the invention. There may be various implementations of G-MKC. An embodiment implements Greedy version of MKC, that is, Greedy Min K-Cut (G-MKC) heuristic and provides generic steps for one of the possible implementation of G-MKC (algorithm 2, FIG. 7).

First, the input partition in the variable φ (line 2, algorithm 2) is read. Then, an attempt is made to try to find an edge within φ with minimum traffic flow (that is, two NF with minimum traffic exchange among them). That edge is added to the set μᵢⱼ (lines 6-7, algorithm 2). The flow of the selected edge is also added in to the variable Δ^{out}(line 8, algorithm 2), which is then used in algorithm 1, as explained earlier. is partitioned along the edges in μᵢⱼ (line 9, algorithm 2). If there are two disjoint partitions (line 10, algorithm 2), the partitions P′ and P″ are returned along with Δ^{out}(line 13, algorithm 2). If not, flow continues until μᵢⱼ does not include all the links in the given partition (line 5, algorithm 2), which means no further partition is possible.

If valid partitions, P′ and P″ are present, they are pushed to K (line 21-22, algorithm 1) and an attempt is made to try to allocate them in the while-loop again. If no such valid partitions are found, a failure is returned. Once all the needed instances (outer while-loop, line 7, algorithm 1) of all partitions in K (inner while-loop, line 10, algorithm 1) are allocated to PM, the allocation variable x is returned. This process is repeated for all procedures to be placed. Note, in the end, it up to the NFV-Mano to decide the threshold to merge the instances of the same VNF into single one as per the system parameters and the threshold values, which might vary as per the PM capacities and other system management parameters and overheads.

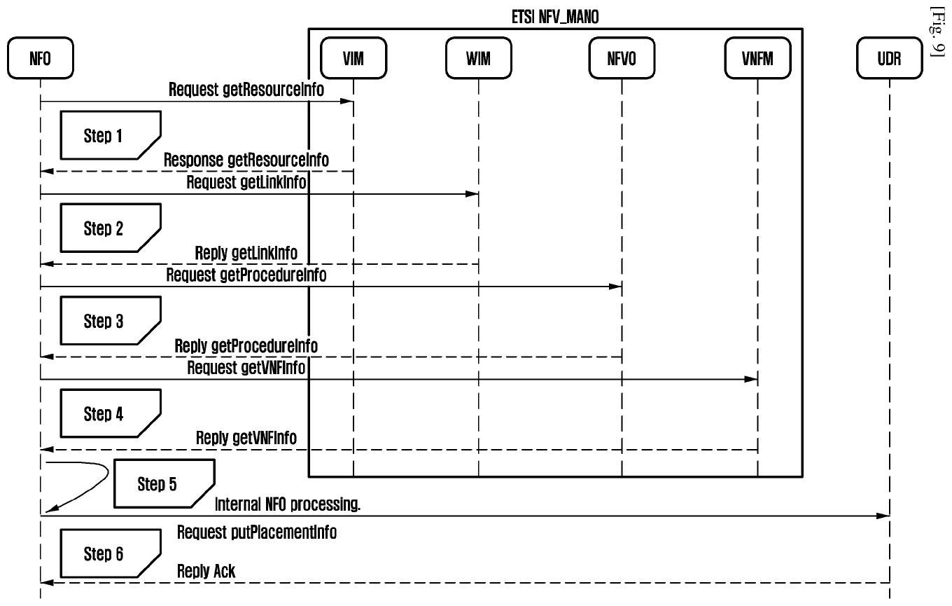

The flowchart for the embodiment is shown in FIG. 8. This flowchart shows both the algorithms, algorithm 1 (FIG. 6) within the dashed rectangle and algorithm 2 (FIG. 7) outside the dashed rectangle.

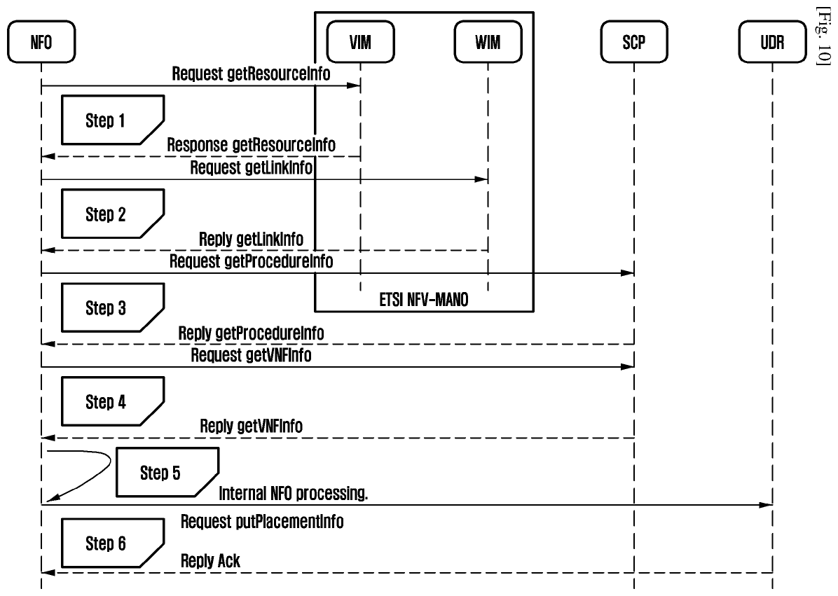

Scenario I: The process and interactions between the control plane entity NFO and other respective components are shown as a call-graph diagram in FIG. 9 and FIG. 10. In FIG. 9, the information mentioned in previously mentioned features (B) and (C) is obtained from NFV-MANO by implementing the respective calls with NFV-MANO. This is herein referred to as Scenario I.

The NFO initializes tuple (S, E, R), tuple P^{(t)}, and tuple F^{(t)}, to enable the receiver to send the needed information regarding servers, procedures and VNFs, in the desired format. It also initializes the variable

$$x \begin{matrix}( t , i ) \\ ( r , s )\end{matrix}$$

to be able to generate the desired placement scheme to do the actual deployment.

NFO then uses the Nnfo interface to make API calls (described previously) to receive the required data form the respective receiver. After receiving the needed information, NFO executes the proposed algorithm described previously to generate an efficient placement scheme, which is then stored in the output variable

$$x \begin{matrix}( t , i ) \\ ( r , s )\end{matrix}$$

(algorithm 1, FIG. 6). It then sends a Put request to UDR to send the placement scheme for storage. The receiver then receives the desired placement scheme to do the actual deployment, and sends back an Ack to NFO. Any system responsible for actual deployment of the VNFs on the underlying infrastructure may retrieve the generated placement scheme from UDR.

Scenario II: In FIG. 10, the execution is similar to FIG. 9, except that the relevant information mentioned in features (B) and (C) described previously is obtained from SCP functionality in 5GC by implementing the respective calls with SCP. This is herein referred to as Scenario II.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-15. (canceled)

16. A method performed by a network function orchestrator (NFO) for placing service function chains (SFCs) in a communication system, the method comprising steps of providing a network function (NF) operable to:
a) register itself with a network resource function (NRF) so as to make itself discoverable to other NFs;
b) gather information and status relating to resources in the communication system, as well as information relating to virtual links if any virtual resource is present in the communication system;
c) gather information and status relating to an underlying physical network, including information relating to physical links, their total and used capacities;
d) gather information related to certain core network (CN) procedures to be implemented;
e) gather information relating to virtual network functions (VNFs) needed to implement the CN procedures and their associated resource requirement;
f) implement the placement of the SFCs for the CN procedures to satisfy given user demands, over available infrastructure resources; and
communicate the placement to at least one further entity.

17. The method of claim 16 wherein in step a) the NF further discovers a unified data repository (UDR).

18. The method of claim 16, wherein in step b), the NF gathers the information from a virtualized infrastructure manager (VIM).

19. The method of claim 16, wherein in step c) the NF gathers the information from a WAN infrastructure manager (WIM).

20. The method of claim 16, wherein in step d) the CN procedures are 5GC or 6GC procedures and the information is gathered from a service communication proxy (SCP) or a network functions virtualization orchestrator (NFVO) respectively.

21. The method of claim 16, wherein in step e) the information relating to VNFs is gathered from a service communication Proxy (SCP) or a network functions virtualization manager (VNFM) respectively.

22. The method of claim 16, wherein in step g) the further entity is one of a unified data repository (UDR) and a network functions virtualization orchestrator (NFVO).

23. A network function orchestrator (NFO) in a communication system, the NFO comprising:
a transceiver; and
at least one processor coupled with the transceiver and configured to:
register itself with a network resource function (NRF) so as to make itself discoverable to other network functions (NFs),
gather information and status relating to resources in the communication system, as well as information relating to virtual links if any virtual resource is present in the communication system,
gather information and status relating to an underlying physical network, including information relating to physical links, their total and used capacities,
gather information related to certain core network (CN) procedures to be implemented,
gather information relating to virtual network functions (VNFs) needed to implement the CN procedures and their associated resource requirement,
implement a placement of service function chains (SFCs) for the CN procedures to satisfy given user demands, over available infrastructure resources, and
communicate the placement to at least one further entity.

24. The NFO of claim 23, wherein the at least one processor is further configured to:
discover a unified data repository (UDR).

25. The NFO of claim 23, wherein the at least one processor is further configured to:
gather the information relating to the resources in the communication system from a virtualized infrastructure manager (VIM).

26. The NFO of claim 23, wherein the at least one processor is further configured to:
gather the information relating to the underlying physical network from a WAN infrastructure manager (WIM).

27. The NFO of claim 23, wherein the at least one processor is further configured to:
wherein the CN procedures are 5GC or 6GC procedures and the information relating to the certain CN procedures to be implemented is gathered from a service communication proxy (SCP) or a network functions virtualization orchestrator (NFVO) respectively.

28. The NFO of claim 23,
wherein the information relating to the VNFs is gathered from a service communication proxy (SCP) or a network functions virtualization manager (VNFM) respectively.

29. The NFO of claim 23,
wherein the further entity comprises one of a unified data repository (UDR) and a network functions virtualization orchestrator (NFVO).
